(19) United States
(12) Patent Application Publication
(10) Pub. No.: US 2026/0244203 A1
(43) Pub. Date: Aug. 20, 2026

(54) HANDLING MACHINE COMPRISING A REMOVABLE CONTROL CONSOLE AND CORRESPONDING MACHINE CONTROL METHOD

(71) Applicant: MANITOU BF, ANCENIS (FR)

(72) Inventors: David LEON, ANCENIS (FR); Thierry LEHMANN, ANCENIS (FR)

(21) Appl. No.: 19/164,992

(22) PCT Filed: Mar. 15, 2024
(86) PCT No.: PCT/FR2024/050314

§ 371 Date: Sep. 12, 2025

(30) Foreign Application Priority Data
Mar. 17, 2023 (FR) FR2302517

(51) Int. Cl. G05D 1/222; B66F 9/065; B66F 17/00; G05D 1/227; G05D 1/82

(52) U.S. Cl. CPC G05D 1/2235; B66F 9/0655; B66F 17/003; G05D 1/227; G05D 1/82

(57) ABSTRACT

The invention relates to a handling machine that comprises a control console (12) that can be removed from a docking support (212) present in a control station, and a processing unit configured to authorize the operation of the machine in a nominal mode (M1), when the presence of the driver on the seat (2021), the fastened state of the seat belt (2022) and the state whereby the control console is positioned in or on the docking support are detected, and to limit the operation of the machine to a degraded operating mode (M2) when the removed state of the console from the docking support (212) or the absence of the driver on the seat or the unfastened state of the seat belt is detected. In the state whereby it is positioned in or on the docking support, the control console is pivotably mounted so as to form a steering control component. The invention also relates to a corresponding machine control method.

### FIELD OF THE INVENTION

The present invention generally relates to handling machines and to controlling the machine so that it can move on the ground and/or for handling a load or a person.

Such a machine notably can be produced in the form of a truck with a telescopic arm, a mechanical shovel, a bucket loader, a nacelle, a reach truck or another type of machine.

### PRIOR ART

Handling machines are known from the prior art that include a removable control console allowing a driver to control these machines from inside the control station of the machine or while remaining on the ground from outside the control station of the machine.

However, improving the safety, the comfort and the precision when controlling such machines would be beneficial.

The aim of the present invention is to propose a new handling machine and a corresponding method for overcoming all or some of the aforementioned problems.

### SUMMARY OF THE INVENTION

To this end, the aim of the invention is a handling machine for handling a load or a person comprising:
a rolling chassis;
a system for moving the rolling chassis of the machine on the ground;
a handling system for the machine supported by the rolling chassis;
characterized in that the machine comprises:
a removable control console that comprises a control device for controlling the system for moving the rolling chassis of the machine on the ground and a control device for controlling the handling system of the machine;
a control station supported by the rolling chassis, the control station comprising:
a support for docking the control console configured to allow the control console to be removably docked;
a seat, and a sensor for detecting the presence of a driver on the seat, such as a weight sensor in the seat;
a seat belt for the driver and a system for fastening and unfastening the seat belt;
the machine further comprising a processing unit that comprises:
a module for detecting the presence of the driver configured to detect the presence or the absence of the driver on the seat based on the data provided by the sensor for detecting the presence of a driver on the seat;
a module for detecting the state of the seat belt for detecting the fastened or unfastened state of the seat belt of the driver;
a module for detecting the state of the control console configured to detect the positioned or removed state of the removable control console relative to the docking support;
a radio communication module configured to communicate with a radio communication module of the control console;
the processing unit further comprising a module for managing the operation of the machine configured to:
allow the machine to operate in an operating mode, called nominal mode, when the presence of the driver on the seat, the fastened state of the seat belt and the state whereby the control console is positioned in or on the docking support are detected, the control console being configured, in said nominal mode, to allow at least part of the system for moving the rolling chassis of the machine on the ground and of the system for handling the machine to be controlled; and
limit the operation of the machine to an operating mode, called degraded mode, when at least one of the following conditions is met:
the control console is removed from the docking support in the control station;
the absence of the driver on the seat of the control station is detected;
the seat belt of the driver is unfastened;
the degraded operating mode being an operating mode in which:
the maximum authorized value of at least one operating parameter of the machine is reduced relative to the maximum authorized value of said operating parameter of the machine in nominal mode; and/or
a function of the machine available in nominal mode is deactivated in degraded mode;
the radio communication module of the control console being configured to communicate with the radio communication module of the processing unit to allow the control console to control the ground movement of the rolling chassis and/or the handling system when the control console is removed from the docking support;
and in that, in the state whereby it is positioned in or on the docking support, the control console is pivotably mounted relative to or with the docking support so as to form a steering control component, such as a steering wheel, via said pivoting mobility so as to allow the driver present in the control station of the machine to control a system for steering the wheels of the machine by pivoting the control console.

By virtue of the rotary mobility of the control console, the machine thus can be devoid of a conventional steering wheel permanently connected to the wheel steering system, by virtue of the removable control console that can be used as a steering wheel.

Having a removable control console that can be used as a steering component by being pivotably mounted relative to or with the docking support allows a steering wheel to be formed that the user (driver) can grasp with both hands, which promotes the comfort and the driving precision of the vehicle when the user is inside the vehicle, unlike the use of a button or joystick, while benefiting from the possibility of controlling the machine with this control console outside the machine by virtue of its removability and of the presence of the control device for controlling the movement system that forms part of the control console.

According to one embodiment, in the state whereby it is positioned in or on the docking support, the entire removable control console is pivotably mounted relative to the rolling chassis of the machine in order to control the direction of the vehicle. When the control console is in the state whereby it is removed from the docking support, the control device, for example, a joystick, for controlling the movement system offers one or more movements relative to the body of the control console that supports said system, in order to allow the user to control the movement of the machine on the ground.

The user can thus control, for example, using one or more fingers of one hand, the movement of the machine on the ground from outside the machine, including the direction of travel. The activation of the degraded operating mode when the control console is in the removed state means that it is possible to take into account the fact that control using the control device for controlling the movement system that is mounted on the body of the control console is less precise and less comfortable to use than the steering component formed by the control console itself, such as a steering wheel, when the control console is positioned in or on the docking support and that the user can pivot with both hands in order to steer the vehicle.

The limitation in the performance capability or the capacity of the machine when the user controls the machine with the control console, but without said control console being positioned in its docking support in the control station, thus allows the user to control the machine from outside the control station of the machine, while reducing the risk of an accident.

In particular, when the handling system comprises a lifting arm, reducing the maximum speed of movement of the machine on the ground, and/or the maximum acceleration, limits the instability of the machine and therefore the risk of the machine overturning in order to take into account the fact that it is difficult for a user located outside the control station of the machine to judge or feel the effects of controlling the machine in terms of the instability of the machine or because controlling the machine is more difficult for a user located outside the control station, as opposed to the machine being controlled by a user present in the control station.

The nominal operating mode is a mode in which the machine has maximum operating capacities (i.e., capacities corresponding to the maximum operating values that nevertheless can be limited by safety parameters that are defined, for example, in charts, for example, as a function of the weight of the handled load and/or of the angle of the arm and/or of the lateral incline of the machine, etc.). In other words, in nominal mode, all the functions of the machine can be used up to their maximum value.

The machine can also comprise one or more of the following features taken in any technically permissible combination.

According to one embodiment of the invention, in degraded mode, the processing unit is configured to limit the maximum value of the speed, or of the acceleration, of movement of the rolling chassis of the machine on the ground relative to the maximum value of the speed, or of the acceleration, permitted in nominal mode.

According to one embodiment of the invention, the handling system comprises a lifting arm that can be inclined relative to the rolling chassis, between a low position and a high position, the lifting arm being provided with handling equipment, such as a work platform or a fork system, the lifting arm preferably being pivotably mounted at the rear of the machine, and wherein, in degraded mode, the processing unit is configured to limit the maximum permitted value of the angular speed and/or of the angular acceleration of the lifting arm relative to the maximum value of the angular speed and/or of the angular acceleration of the lifting arm permitted in nominal mode.

According to one embodiment of the invention, the handling system comprises a lifting arm that can be inclined relative to the rolling chassis, between a low position and a high position, the lifting arm being provided with handling equipment, such as a work platform or a fork system, the lifting arm being telescopic and preferably being pivotably mounted at the rear of the machine, and, in degraded mode, the processing unit is configured to limit the extension speed and/or the maximum permitted extension acceleration of the lifting arm relative to the extension speed and/or the maximum permitted extension acceleration of the lifting arm in nominal mode.

According to one embodiment of the invention, in the state whereby it is positioned in or on the docking support, the control console is pivotably securely mounted with the docking support, which comprises a shaft, called steering shaft, coupled to the wheel steering system such that pivoting the control console pivots the steering shaft relative to the rolling chassis.

According to one embodiment of the invention, the control station of the machine is devoid of an additional steering control component that can be used instead of the control console.

According to one embodiment of the invention, the control console comprises a rechargeable battery and an electrical connection system connected to the battery, the electrical connection system of the control console is configured, in the state whereby the control console is positioned in or on the docking support, to be connected to an electrical connection system of the docking support to allow the battery to be recharged by an electrical power supply system of the machine.

According to one embodiment of the invention, the module for detecting the state of the control console is connected to the electrical connection system of the docking support so as to detect the position of the control console in or on the docking support when the electrical connection system of the control console is connected to the electrical connection system of the docking support.

According to one embodiment of the invention, the electrical connection system of the control console is located on a lateral face and/or on a lower face, as opposed to an upper face of the control console that supports the control device for controlling the system for moving the rolling chassis of the machine on the ground and the control device for controlling the handling system of the machine, while the electrical connection system of the docking support is located on a lateral face and/or on an upper face of the docking support, so as to allow the electrical connection systems to be automatically connected to each other when the user places the control console in the docking support under the effect of gravity.

According to one embodiment of the invention, the machine comprises a locking system for locking the control console so as to hold it in position in or on the docking support, and for unlocking the control console from the docking support so as to remove it.

According to one embodiment of the invention, the device for controlling the system for moving the rolling chassis of the machine on the ground is configured to allow the following to be controlled:
the speed and/or the acceleration of the movement of the rolling chassis of the machine on the ground; and
the line of travel of the rolling chassis of the machine on the ground; and
at least in degraded mode, the direction of the machine in order to allow a user to control the direction of movement of the rolling chassis of the machine on the ground from outside the control station.

According to one embodiment of the invention, the handling system comprises a lifting arm that can be inclined relative to the rolling chassis, between a low position and a high position, the lifting arm being provided with handling equipment, such as a work platform or a fork system, movably mounted relative to the lifting arm, the lifting arm preferably being telescopic and preferably being pivotably mounted at the rear of the machine, the control device for controlling the handling system of the machine is configured to allow the following to be controlled: the angle of incline of the lifting arm relative to the rolling chassis and/or the movement of the equipment relative to the lifting arm.

The invention also relates to a method for controlling a machine for handling a load or a person according to any one of the preceding embodiments, the method comprising the following steps of:
with the removable control console being positioned in or on the docking support of the control station, with the driver being seated on the seat of the control station and the seat belt of the driver being fastened:
detecting the positioned state of the removable control console in or on the docking support;
detecting, via the processing unit, the presence of a driver on the seat;
detecting, via the processing unit, the fastened state of the seat belt of the driver; and
authorizing, via the processing unit, the operation of the machine in nominal mode;
and, when the removable control console is removed from the docking support of the control station, or the driver is not seated on the seat of the control station or the seat belt of the driver is unfastened:
detecting, via the processing unit, the state whereby the removable control console is removed from the docking support, or the absence of the driver on the seat of the control station or the unfastened state of the seat belt of the driver; and
limiting, via the processing unit, the operation of the machine to the degraded mode;
with the degraded operating mode being an operating mode in which:
the maximum permitted value of at least one operating parameter of the machine is reduced relative to the maximum permitted value of said operating parameter of the machine in nominal mode; and/or
a function of the machine available in nominal mode is deactivated in degraded mode;
and, when the removable control console is positioned in or on the docking support, the driver controlling the direction of the wheels of the machine by pivoting the control console relative to or with the docking support;
and, when the removable control console is removed from the docking support, controlling the direction of the wheels of the machine by the driver acting on the control device for controlling the ground movement system that forms part of the control console.

### BRIEF DESCRIPTION OF THE DRAWINGS

Further features and advantages of the invention will become more apparent from the following description, which is purely illustrative and non-limiting and must be read with reference to the appended drawings, in which:

FIG. 1 is a schematic side view of a lifting arm handling machine according to one embodiment, the handling machine comprising a control console that is held by an operator outside the control station and that allows the movement of the machine on the ground and/or the movement of the handling system of the machine to be controlled;

FIG. 1A is a top view of a removable control console according to one embodiment of the invention, the control console comprising a control device for controlling the movement of the machine on the ground and a control device for controlling the movement of the handling system of the machine;

FIG. 1B is a schematic view of a processing unit of a handling machine according to one embodiment, the processing unit comprising a radio communication device and devices for determining various parameters or states of elements of the machine, the processing unit allowing the machine to be controlled in different operating modes according to the determined data (parameters or state);

FIG. 2 is a partial perspective view of a handling machine according to one embodiment of the invention, with the user occupying a control station in order to physically position the control console on or in a docking support (also called hosting station);

FIG. 2A is a partial perspective view from the inside of a control station of a handling machine according to one embodiment of the invention, such as the machine of FIG. 2, with the user being seated and being able to turn the removable control console like a steering wheel, which control console is positioned in or on a docking support, in order to steer the machine;

FIG. 3 is a schematic view of a removable control console in a state mechanically coupled to a docking support, according to a first embodiment of the invention, so that pivoting the console causes the docking support, which is intended to be connected to the steering system of the machine, to pivot, with the docking support preferably comprising a system for locking the control console relative to the docking support;

FIG. 3A is a schematic view of a docking support according to a second embodiment of the invention, configured to allow a removable control console of a handling machine to be docked, with the docking support preferably comprising a system for locking the control console relative to the docking support, as well as the presence of components, such as buttons, for controlling ancillary functions;

FIG. 4 is a schematic view of a docking support according to a third embodiment of the invention, configured to allow a removable control console of a handling machine to be docked, with the docking support being adapted to allow the control console to be held or detached relative to the docking support and to allow the control console to be pivotably coupled to the docking support;

FIG. 5 is a schematic view of a locking/unlocking system configured to allow the removable control console to be kept attached (fastened) or detached (unfastened) relative to the docking support in a handling machine according to one embodiment of the invention;

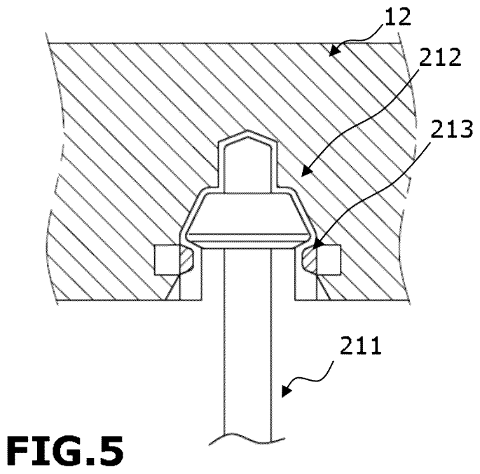

FIG. 6 is a schematic view of a rotary docking support connected to the steering system of a handling machine according to one embodiment, and of a removable control console, with the handling machine being configured to allow a battery of the control console to be electrically recharged when the control console is in the state whereby it is electrically connected to the docking support and to determine the electrically connected or unconnected state of the removable control console to/from the docking support;

FIG. 7 is a flowchart comprising steps of a method for controlling the machine according to one embodiment.

### DETAILED DESCRIPTION

A more detailed description of the invention is set forth hereafter with reference to the appended drawings, which show embodiments of the invention. In the drawings, the size and the relative sizes of the elements can be exaggerated for the sake of clarity. Similar numbers refer to similar elements throughout all the drawings. However, the invention can be implemented in many different forms and should not be understood to be limited to the embodiments disclosed herein.

A reference throughout the specification to “an embodiment” means that a functionality, a structure, or a particular feature described with reference to an embodiment is included in at least one embodiment of the present invention. Thus, the appearance of the expression “in one embodiment” at various points throughout the specification does not necessarily refer to the same embodiment. In addition, the functionalities, structures, or particular features can be combined in any suitable manner in one or more embodiments.

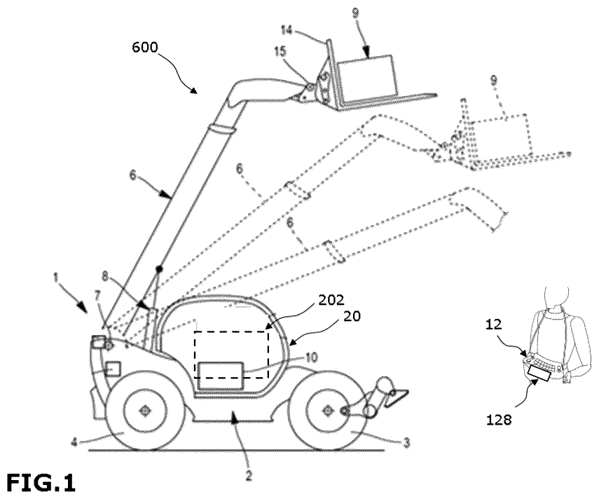

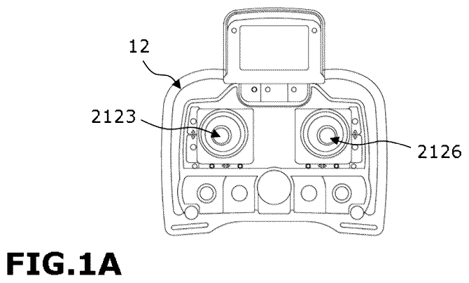

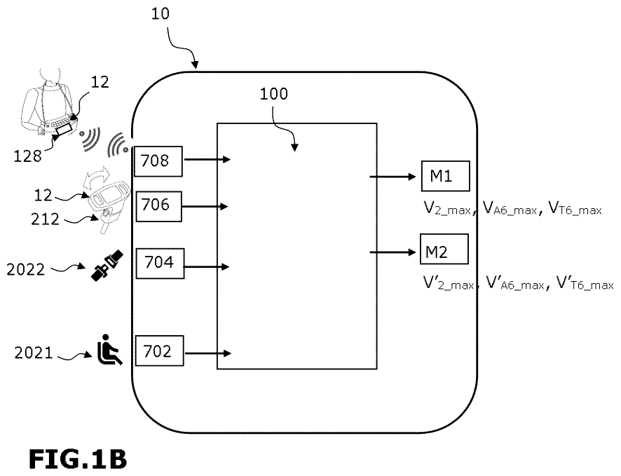

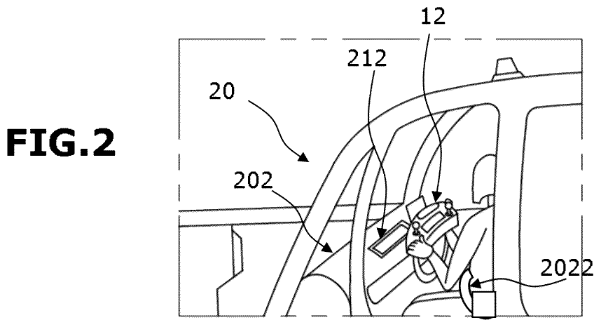

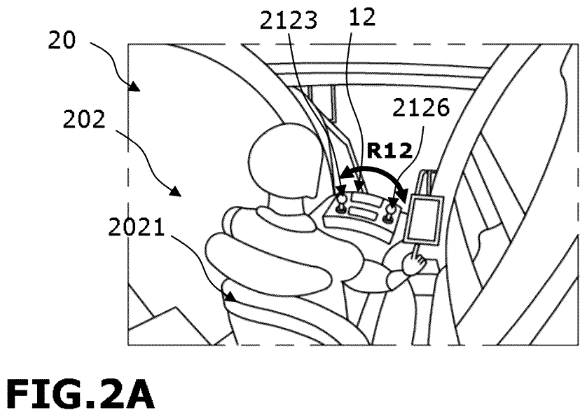

With reference to the figures, a handling machine 1 is proposed that comprises a rolling chassis 2 supporting a control station 202 (for example, inside a cabin 20) and a handling system 600 for handling a load or a person supported by the rolling chassis 2, as illustrated in FIGS. 1 and 2, for example.

The rolling chassis 2 can be supported on the ground by means of a front axle 3 and a rear axle 4.

FIG. 1 shows an example of a handling machine 1 with a handling arm. As a variant, the handling machine can be another type of machine, such as a reach truck.

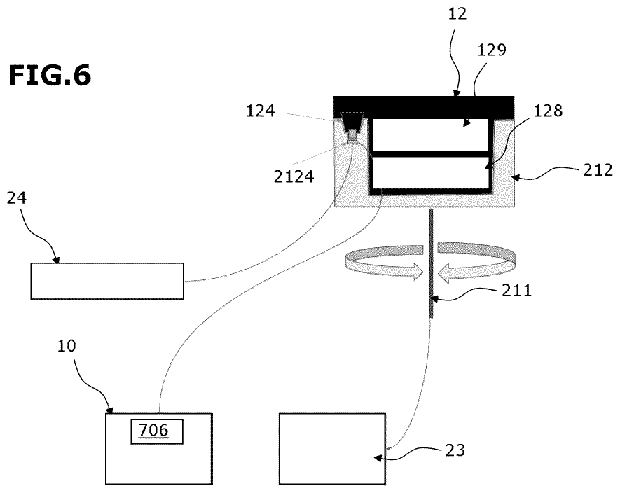

The handling machine 1 comprises a motorized system for moving the rolling chassis of the machine on the ground, also called advance system. The advance system of the machine comprises, for example, an electric motor and/or an internal combustion engine, and a transmission system for the wheels. The machine also comprises a steering system 23 (FIG. 6) that allows the direction of at least some of the wheels of the machine to be controlled in order to direct the movement of the machine.

The rolling chassis 2 supports a handling system 600 and an actuation system, such as a cylinder system, allowing said handling system 600 to be moved relative to the rolling chassis 2. The handling system 600 in FIG. 1 is a load handling system, but can be a person handling system.

As described hereafter, the handling machine includes a processing unit 10 (also called control unit), comprising, for example, a computer, which allows the handling machine to be controlled, and which notably allows the movement of the machine on the ground and the handling system to be controlled, such as the position of the arm 6, via a human-machine interface. The human-machine interface comprises at least one control console 12 as described hereafter.

### Handling System

The handling system 600 comprises handling equipment 14, such as a fork or bucket system or a work platform (basket), and a device 6 for at least raising and lowering the load-bearing equipment 14, such as a lifting arm. The handling system 600 can also comprise a system for moving the equipment 14 relative to the device 6 for raising and lowering the equipment 14.

According to one embodiment of the invention, and as illustrated in FIG. 1, the handling system 600 comprises an arm 6, usually called lifting arm, with an articulated connection on the rolling chassis 2 so as to be able to be moved between a lowered position and a raised position. In the case of a reach truck, the handling system comprises a mast equipped with a fork system slidably mounted along the mast.

The lifting arm 6 (or handling arm) is mounted on the rolling chassis 2 and can be oriented about an axis of rotation 7. In particular, said axis of rotation 7 is horizontal when the rolling chassis 2 is resting on horizontal ground. According to a particular aspect, the arm 6 projects toward the front of the machine. According to one embodiment, the axis 7 is closer to the rear axle than to the front axle of the machine.

As explained hereafter, the maximum authorized value of the angular speed or the angular acceleration of the arm relative to the rolling chassis can depend on the positioned or non-positioned state of the control console in or on its docking support in the control station 202.

The arm 6 is equipped with handling equipment, which, in the illustrated example, comprises a load carrier 14, such as a fork or bucket system, with an articulated connection to the arm 6 via a link 15 and being configured to support a payload 9. As a variant, said handling equipment can be a work platform.

According to one embodiment of the invention, the arm 6 is of the telescopic type. The arm 6 thus comprises at least two deployable segments, for example, using a deployment cylinder, not shown, arranged between the at least two segments. As a variant, the arm can be a non-telescopic arm.

As explained hereafter, the speed or acceleration for extending the arm can depend on the positioned or non-positioned state of the control console in or on its docking support.

As illustrated in the example of FIG. 1, the device for actuating the arm 6 particularly includes a lifting actuator, for example, a hydraulic cylinder 8, which allows the arm 6 to be moved upwards and downwards about the horizontal axis 7. As a variant, the lifting actuator can be an electric cylinder.

The processing unit 10 can be configured to control the lifting actuator, for example, by means of a hydraulic circuit (not shown), as a function of the operator using a control device 2126 of the control console 12.

The hydraulic circuit can comprise a hydraulic pressure source and a hydraulic distributor interposed between the hydraulic pressure source and a solenoid valve for controlling the hydraulic cylinder 8.

As a variant, the handling machine can be fully electric.

### Control Station

The control station 202 comprises a seat 2021 and a seat belt system. The seat belt system comprises a seat belt 2022 and a device for closing and opening the seat belt, the state of which is detected by the device 704 of the processing unit.

The control station 202 can be located inside a cabin 20 with a door allowing an operator to occupy the control station 202 of the cabin 20 in order to control the machine.

The control station 202 comprises a docking support 212 for the control console 12.

The removable control console 12 allows a driver to control the movement of the machine on the ground from inside the control station 202 of the machine when the control console 12 is in a state whereby it is physically coupled to a docking support 212 present in the control station 202, or from outside the machine when the control console is in a state whereby it is removed from the docking support, while remaining on the ground, or even from a work platform of the machine when the machine is equipped with such a platform.

According to a particular aspect, controlling the movement of the machine on the ground includes the direction of travel, the line of travel (forward/reverse), and preferably the speed of movement (acceleration and braking). Preferably, the control console 12 also allows the handling system 600 to be controlled from inside the control station of the machine in the state whereby the control console 12 is physically coupled to the docking support present in the control station, or from outside the machine in the state whereby the control console is removed from the docking support.

As described hereafter, the removable control console according to the invention is configured to improve safety when controlling the handling machine compared to the known solutions of the prior art by limiting at least some of the capabilities or functionalities of the machine when the control console 12 is removed from the docking support 212 in order to be used outside the control station 202.

### Processing Unit

As mentioned above, the machine comprises a processing unit 10, such as a computer.

The processing unit 10 comprises a module 702 for detecting the presence of the driver in the control station 202 of the machine and a module 704 for detecting the seat belt, i.e., the buckled or open state of the seat belt of the driver. The processing unit 10 also comprises a module 706 for detecting the state whereby the control console 12 is positioned in or on the docking support 212.

Detecting the buckled (active) state of the seat belt and the presence of the driver in the control station (for example, via a weight sensor in the seat of the driver), combined with detecting the state whereby the control console 12 is positioned in or on the docking support 212, means that it is possible to determine that the driver is in a situation for controlling the machine from inside the control station 202 under safety conditions that are suitable for authorizing the operation of the machine in nominal mode (described hereafter).

The processing unit 10 also comprises a radio communication module 708 configured to communicate with a radio communication module 128 of the control console 12, so as to allow the machine to be controlled with the control console 12 via a radio transmission when the control console is removed from the docking support 212 of the machine and is used by an operator, for example, outside the control station of the machine, in degraded mode (described hereafter).

### Removable Control Console

The control console 12 comprises a first device 2123 for controlling the movement of the machine on the ground (as is more specifically illustrated in the example of FIG. 1A), and a second device 2126 for controlling the handling system 600, a radio communication device 128, and preferably a battery 129. The devices 2123 and 2126 are levers or joysticks, for example.

In the event that the handling system 600 comprises a lifting arm 6 and equipment 14 that can move relative to the arm 6, provision can be made for the second control system 2126 for controlling the handling system 600 to be configured to allow the raising and lowering of the arm to be controlled, as well as the movement (for example, the incline) of the equipment relative to the arm.

According to a preferred embodiment of the invention, and as illustrated in the example of FIG. 6, the control console 12 comprises an electrical connection system 124 connected to a battery 129 of the control console. The electrical connection system 124 of the control console 12 is configured, in the state whereby the control console 12 is positioned in or on the docking support 212, to be connected to the electrical connection system 2124 of the docking support 212 to allow the battery 129 to be recharged by an electrical power supply system 24 of the machine that preferably comprises a battery.

The electrical connection system 124 and the electrical connection system 2124 can be engaged by joining the lateral faces of the console 12 and of the support 212, and/or by joining the lower face of the console 12 and the upper face of the support 212. Indeed, the electrical connection system 124 of the control console 12 can be located on a lateral face and/or on the lower face, as opposed to the upper face of the control console 12 that supports the control device 2123 of the system for moving the rolling chassis of the machine on the ground and the control device 2126 for controlling the handling system 600 of the machine, while the electrical connection system 2124 of the docking support 212 can be located on a lateral face and/or on the upper face of the docking support 212.

The device 706 is connected to the electrical connection system 2124 of the docking support 212 so as to detect the coupling of the control console 12 in or on the docking support 212 when the electrical connection system 124 of the control console 12 is connected to the electrical connection system 2124 of the docking support 212.

According to one embodiment, the machine is devoid of a redundant steering control component, i.e., of an additional steering control component that would allow the steering control function of the control device 2123 of the control console for controlling the movement of the machine on the ground to be replaced when the control console is in the state whereby it is removed from its docking support, and therefore would allow the machine to be steered without the control console. This avoids forgetting to bring the control console when the machine is delivered to a worksite. The removability of the control console and the lack of redundancy of at least the steering command limits the risk of the machine being stolen when the control console is removed and stored in a secure location.

According to one embodiment, provision also can be made for the machine to be devoid of a redundant control component for the handling system, i.e., an additional control component for the handling system that would replace a handling control function of the device 2126 of the control console in the state whereby the control console is removed from its docking support, and therefore would allow the handling system of the machine to be controlled without the control console. This limits the manufacturing costs of the machine.

Provision can be made for none of the controls present on the control console to be repeated in the control station itself or for only some of the controls to be repeated, such as a speed or acceleration control, for example, an acceleration pedal present in the control station corresponding to an acceleration function of the device 2123 for controlling the ground movement of the machine from the control console. Similarly, provision can be made for none, all or only some of the controls of the handling control device 2126 of the console to be repeated in the control station 202 of the handling machine.

In the state whereby it is physically uncoupled from the support 212, and preferably in the state whereby it is separate from the control station 202 of the machine, the control console 12 is still able to communicate with the processing unit 10 of the machine via a wireless link to allow a user to control the ground movement system (forward and direction, and preferably the speed) of the machine with the first control device 2123 of the control console 12, and to control the handling system 600 with the second control device 2126 of the control console 12.

Preferably, the support 212 comprises a system 213 for locking the control console 12 on or in the support 212. The locking system can be activated and deactivated, in order to allow the control console 12 to remain physically coupled to the support 212 and to be detached.

In particular, the locking system 213 can comprise a clip system for mechanically attaching the control console on the support. In order to ensure correct positioning when clipping, keyways can be attached to the support in order to allow only one position of the control console 12 on or in the docking support 212.

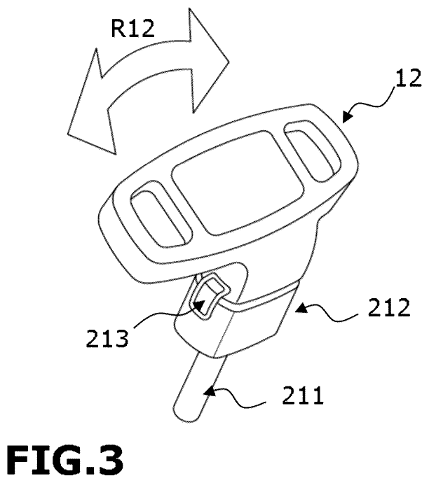

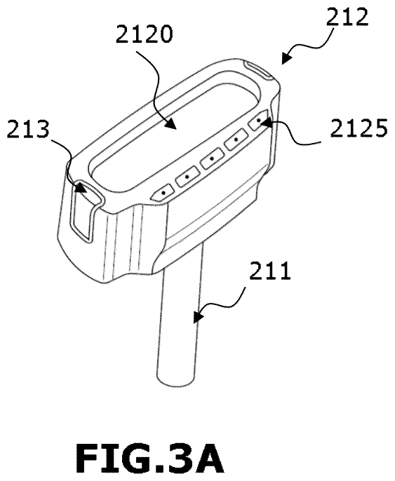

As illustrated in FIG. 3A, for example, provision can be made for the docking support 212 to have a hollow location 2120 for accommodating the control console. The docking support can be provided with control components, such as buttons 2125, for controlling ancillary functions. The control components 2125 can take priority over equivalent control components of the control console when the control console is positioned in or on the docking support, which allows the operating ergonomics to be improved.

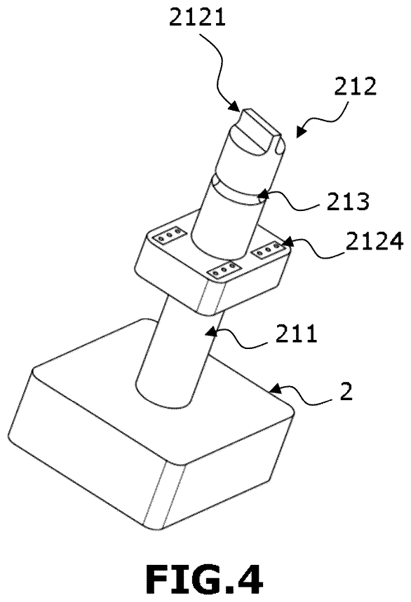

As illustrated in FIG. 4, for example, the support 212 can comprise an indexing system 2121 allowing the position and the orientation of the control console 12 to be defined relative to the support 212, in the state whereby the control console 12 is coupled to the support 212.

Provision can be made to arrange a location in the control station 202 in order to store the console when the machine is no longer in use. In order to avoid theft or vandalism, provision can be made for the control console to be locked in position in or on the docking support or in an anti-theft box provided in the control station (in particular in the cabin).

According to a particular aspect, the control console also comprises additional elements, allowing ancillary functions to be controlled, such as: an audible alarm; lights; indicators; a stabilizer; safety information; a brake control; and/or a camera.

### Steering Wheel

The control console can be used as a steering wheel when it is positioned in or on the docking support 212 inside the control station 202. In the state whereby it is positioned in or on the docking support 212, the control console is pivotably coupled to the docking support rotatably mounted relative to the rolling chassis and connected to the steering system 23 of the machine, as illustrated in FIG. 6, for example.

Various technical means can be implemented for controlling the direction of the machine with the rotational movement of the control console:
by a mechanical connection: the docking support of the control console can be mechanically connected to a wheel steering component (for example, a steering column, an orbitrol type pump system); or
by an electronic connection: the docking support of the control console can be electrically connected to an angle sensor that sends the angle information to a steering component (for example, an orbitrol type pump system, an electric cylinder) or to the processing unit.

The machine thus can be devoid of a conventional steering wheel permanently connected to the wheel steering system, by virtue of the removable control console that can be used as a steering wheel.

Provision can be made for the processing unit 10 to be configured to control the wheel steering system by controlling a gear reduction ratio and/or progressive steering adapted as a function of the position or speed or angular acceleration of the control console.

As described hereafter, at least some of the performance capabilities or capacities for controlling the ground movement and/or the handling system of the machine is reduced when the control console is removed from the docking support present in the control station to allow the user to control the machine outside the main control station, but with a reduced risk of an accident.

According to one embodiment of the invention, the docking support 212 of the control console 12 comprises a system for rotatably coupling the control console 12 with the support 212. In particular, the support 212 can be rotatably secured to a shaft 211, called steering shaft, that is rotatably mounted relative to the rolling chassis 2, and that forms part of the steering system of the machine or that is mechanically and/or electrically connected to the steering system of the machine.

According to this embodiment of the invention, the control console 12 is configured with the support 212, so that in the state whereby it is physically coupled to the support 212 (i.e., in the state whereby the control console 12 is positioned in or on the docking support 212 with mechanical coupling), the control console 12 can be set into rotation R12 by a user relative to the rolling chassis 2 in order to form a control component for steering the machine.

### Recharging the Battery

As mentioned above, provision can be made for the control console to include a battery 129 that is rechargeable in the state whereby the control console 12 is positioned in or on the docking support 212.

Advantageously, the connection system is configured such that the control console 12 is connected to the docking support 212 simply by placing the control console in the support. This connection allows the following functions:
the battery of the control console is recharged by virtue of the connection with a power supply on the machine;
the position of the control console in the docking support 212 (and therefore in the control station 202) is detected by virtue of the connection with the connector 2124 connected to the detection module 706 of the processing unit.

According to a particular aspect, once the two connectors 124, 2124 are connected together, then recharging of the battery 129 is effective without any additional action on the part of the user. Furthermore, provision can be made for the connector 124 to detect the connection of the control console 12 to the support 212 and recharging the battery of the control console 12 does not require clamping or locking with the connector 2124.

The connector 2124 can be of the IP2X type.

### Machine Operating Modes

The processing unit 10 comprises a module 100 for managing the operation of the machine that authorizes or adjusts (parameter) the operation of the machine as a function of the data acquired by the modules 702, 704 or 706, i.e., according to the seat belt status, whether or not the driver is present in the control station and the positioned or non-positioned state of the control console 12 in or on its docking support 212.

Thus, provision can be made, when the driver is present in the control station, the seat belt is buckled and the control console is physically (and preferably electrically) connected to the docking support, for the module 100 to activate the operation of the machine in a mode M1, called nominal mode, in which the machine can be moved at a given maximum speed V2_max and/or a given maximum acceleration. It is also possible to anticipate that, in nominal mode, the handling arm can be raised with an angular speed (and/or an acceleration) with a given maximum value VA6_max, and that the arm, when it is telescopic, can be controlled to extend the telescopic part at an extension speed (and/or acceleration) with a given maximum value VT6_max.

Conversely, when the control console 12 is removed from the docking support 212, then the module 100 limits the operation of the machine to a mode M2, called degraded mode, in which at least one operating parameter of the machine is degraded relative to the nominal mode M1. In particular, the maximum value that at least one given parameter can reach in degraded mode M2 is reduced relative to the maximum value that this parameter can reach in nominal mode M1. The operation of the machine is also limited to the degraded mode M2 when the seat belt is detached or when the absence of a driver on the seat is detected.

The degraded mode is triggered when at least one of the following three conditions is not met:
the control console is positioned in or on the docking support in the control station;
the driver is seated on the seat in the control station;
the seat belt of the driver is detached (unfastened).

Provision can be made for the function M2 to be prevented (and, of course, the nominal mode M1 as well) if the control console is too far from the processing unit 10, for example, when the strength of the radio signal between the radio communication module 708 of the unit 10 and the radio communication module 128 of the console 12 is too low (i.e., below a threshold value).

According to a preferred embodiment of the invention, in degraded mode M2, at least the maximum authorized value of the speed or of the acceleration of the ground movement of the machine is reduced relative to the nominal mode. It is thus possible to anticipate that, in degraded mode, the machine can be moved at a given maximum speed with a value V′2_max lower than the value V2_max of the nominal mode and/or at a given maximum acceleration with a value Accmax′ lower than the value Accmax of the nominal mode.

Provision also can be made so that, in degraded mode, the handling arm can be raised with an angular speed (and/or acceleration) with a given maximum value V′A6_max lower than the value VA6_max of the nominal mode, and/or so that the arm, when it is telescopic, can, in degraded mode, be elongated with an extension speed (and/or acceleration) V′T6_max that remains lower than the maximum value VT6_max of the nominal mode. According to a particular aspect, the maximum authorized value of the lifting angle and/or the maximum authorized extension length value does not depend on the activated nominal or degraded mode.

By way of an example, when the machine is equipped with such a work platform, the maximum movement speed or acceleration can be reduced when the operator uses the control console outside the control station, i.e., either from the work platform or outside the machine itself.

Provision thus can be made for the nominal mode to allow operation without any particular restriction other than restrictions that would apply to the machine irrespective of its operating mode, such as restrictions resulting from the construction of the machine or from a safety rule, for example, relating to the detection of instability. By contrast to the nominal mode, activating the degraded mode results in one or more operating restrictions of the machine in order to take into account the fact that the control console is not positioned in the docking support of the control station.

The mode M2 thus allows the operation of the machine to be authorized while limiting one or more functions.

According to one embodiment of the invention, the processing unit 10 is configured, when the state is detected whereby the electrical connection system 124 of the control console 12 is connected to the additional connection system 2124 of the support 212 (it follows that the control console is positioned in the docking support), to allow at least the handling system 600 of the machine to be controlled, and preferably also the system for moving the machine on the ground, by means of the control console 12. Said authorization is preferably subject to one or more predefined conditions, such as fastening the seat belt and/or detecting the presence of the driver in the control station.

The control of at least some of the handling system 600 of the machine, and preferably also of at least some of the system for moving the machine on the ground, by means of the control console 12, can be authorized by the processing unit 10, even when the battery 129 of the control console 12 is being recharged by the electrical power supply system 24 of the machine.

As mentioned above, when the electrical connection system 124 of the control console 12 is disconnected from the additional connection system 2124 of the support 212, the processing unit 10 then activates the degraded operating mode. The control console 12 is configured to communicate with the processing unit 10 of the machine via a wireless link in order to allow a user to:
control the ground movement system (forward and direction and preferably speed) of the machine with the first control device 2123 of the control console 12; and
control the handling system 600 with the second control device 2126 of the control console 12.

In this state whereby the electrical connection system 124 of the control console 12 is disconnected from the additional connection system 2124 of the support 212 (which reflects a state whereby the control console is removed from its docking support), the machine operates in degraded mode in which at least some of the controls of the system for moving the machine on the ground and of the handling system 600 is limited relative to the nominal mode.

The control console 12 thus can be configured such that:
(i) in the state whereby it is coupled to the docking support 212, the battery 129 of the control console 12 is recharged by the electrical power supply system 24 of the machine, and at least the handling system 600 of the machine can be controlled with the second control device 2126 of the control console 12, and, preferably, the system for moving the machine on the ground can be controlled with the first control device 2123 of the control console 12. As a variant, provision can be made for at least some of the controls that can be made with the first control device 2123 of the control console 12 to be deactivated and for the device for moving the machine on the ground to be controlled by a separate control system included in the control station, such as an acceleration pedal for controlling the acceleration or speed of the machine. The direction of the machine then can be controlled using the control console as a steering wheel, as explained above when the control console is pivotably mounted relative to the rolling chassis in the state whereby it is coupled to the docking support.
(ii) in the state whereby it is uncoupled from the support 212, for example, in the state whereby it is removed from the control station 202 of the machine, the control console 12 is able to communicate with the processing unit 10 of the machine by a wireless link in order to allow a user to:
control the ground movement system (forward and direction) of the machine with the first control device 2123 of the control console 12; and
control the handling system 600 with the second control device 2126 of the control console 12;
with at least some of the control of the ground movement system and of the handling system 600 nevertheless being degraded (preferably at least the maximum value of the speed and/or the acceleration of movement of the machine on the ground) relative to the controls available in the state whereby the control console 12 is positioned in or on the docking support 212.

### Sensor System

The handling machine comprises a sensor system for providing the processing unit of the machine with signals. The sensor system can include all or some of the following sensors:
a sensor for sensing the angle of the lifting arm 6;
a sensor for sensing the position of the handling equipment 14, such as the angle of incline of the tool holder or of the tool;
a sensor for sensing the extension length of the lifting arm 6, or for sensing the retracted or extended state of the arm, when said arm is telescopic.

The modules 702, 704, 706 can be considered to be forming or being associated with sensors that respectively allow the detection of the presence of the driver on the seat of the control station, the closed or open state of the seat belt, the state whereby the control console 12 is physically coupled in or on its docking support.

Of course, the sensor system can include other sensors for measuring various parameters of the machine, for example, an incline sensor (longitudinal and/or lateral) of the machine, and/or a sensor for determining the mass of a load borne by the handling system. As mentioned above, the sensor system is connected to the processing unit in order to allow values of various parameters of the handling machine to be determined.

Method for Controlling the Machine with the Control Console

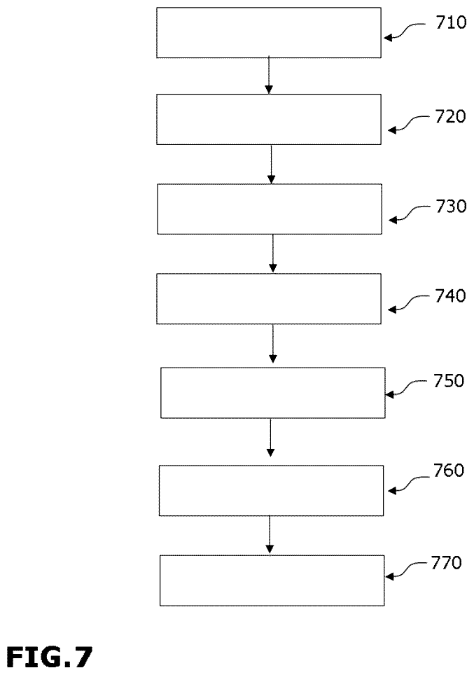

The handling machine described above allows a method for managing the operating mode of the machine to be implemented, an example of which is described hereafter with reference to FIG. 7 in the case of a truck with a telescopic lifting arm where the operator can control the machine from inside or outside the control station of the truck. Of course, the method can be applied to another type of machine as mentioned above.

The user enters the control station 20 of the machine and positions the control console 12 in or on its docking support 212 (step 710). When the control console 12 is positioned in or on the docking support 212, the connector 124 cooperates with the connector 2124 so that the module 706 of the processing unit 10 detects the state whereby the control console 12 is positioned in or on the docking support 212 (step 720).

The module 702 of the processing unit 10 detects that the user is seated on the seat 2021 (step 730). The user fastens the seat belt, which detects the module 704 in step 740.

It will be understood that the order of the detection steps can differ from that described.

The data detected by the modules 702, 704, 706 is acquired by the management module 100, which activates the nominal operating mode M1. In this mode M1, the machine operates normally, in particular with a ground movement speed at the maximum authorized value V2_max and/or a maximum authorized acceleration AccMax.

In the event that the removable control console 12 is removed (step 750) from the docking support 212 of the control station 202: the state whereby the removable control console 12 is removed from the docking support 212 is detected by the module 706 (step 760) and the management module 100 of the processing unit 10 limits the operation of the machine to the degraded mode M2 (step 770). The radio communication module 128 of the control console 12 then communicates with the radio communication module 708 of the processing unit 10 to transmit the commands from the control device 2123 and from the control device 2126 of the control console to the processing unit 10 in order to be able to control the ground movement of the machine and/or the handling system.

The described functions and steps can be implemented in the form of a computer program or via hardware components (for example, programmable gate arrays). In particular, the functions and steps performed by the processing unit or the modules can be carried out by sets of computer instructions or modules implemented in a processor or controller or can be carried out by dedicated electronic components or components of the programmable logic circuit (or FPGA) type, or of an application-specific integrated circuit (or ASIC). It is also possible to combine computer parts and electronic parts.

The processing unit is thus an electronic and/or computer unit. When it has been specified that said unit is configured to perform a given operation, this means that the unit comprises computer instructions and the corresponding execution means for carrying out said operation and/or that the unit comprises corresponding electronic components.

The invention is not limited to the embodiments illustrated in the drawings.

In addition, the term “comprising” does not exclude other elements or steps. Furthermore, features or steps that have been described with reference to one of the embodiments disclosed above also can be used in combination with other features or steps of other embodiments disclosed above.

1. A handling machine for handling a load or a person comprising:
a rolling chassis (2);
a system for moving the rolling chassis of the machine on the ground;
a handling system (600) for the machine supported by the rolling chassis (2);
characterized in that the machine comprises:
a removable control console (12) that comprises a control device (2123) for controlling the system for moving the rolling chassis of the machine on the ground and a control device (2126) for controlling the handling system (600) of the machine;
a control station (202) supported by the rolling chassis (2), the control station (202) comprising:
a support (212) for docking the control console configured to allow the control console (12) to be removably docked;
a seat (2021), and a sensor for detecting the presence of a driver on the seat, such as a weight sensor in the seat;
a seat belt (2022) for the driver and a system for fastening and unfastening the seat belt;
the machine further comprising a processing unit (10) that comprises:
a module (702) for detecting the presence of the driver configured to detect the presence or the absence of the driver on the seat based on the data provided by the sensor for detecting the presence of the driver on the seat;
a module (704) for detecting the state of the seat belt for detecting the fastened or unfastened state of the seat belt of the driver;
a module (706) for detecting the state of the control console configured to detect the positioned or removed state of the removable control console (12) relative to the docking support (212);
a radio communication module (708) configured to communicate with a radio communication module (128) of the control console (12);
the processing unit (10) further comprising a module (100) for managing the operation of the machine configured to:
allow the machine to operate in an operating mode, called nominal mode (M1), when the presence of the driver on the seat (2021), the fastened state of the seat belt (2022) and the state whereby the control console (12) is positioned in or on the docking support (212) are detected, the control console (12) being configured, in said nominal mode (M1), to allow at least part of the system for moving the rolling chassis of the machine on the ground and of the system (600) for handling the machine to be controlled; and
limit the operation of the machine to an operating mode, called degraded mode (M2), when at least one of the following conditions is met:
the control console is removed from the docking support in the control station;
the absence of the driver on the seat of the control station is detected;
the seat belt of the driver is unfastened;
the degraded operating mode being an operating mode in which:
the maximum authorized value of at least one operating parameter of the machine is reduced relative to the maximum authorized value of said operating parameter of the machine in nominal mode; and/or
a function of the machine available in nominal mode is deactivated in degraded mode;
the radio communication module (128) of the control console (12) being configured to communicate with the radio communication module (708) of the processing unit (10) to allow the control console (12) to control the ground movement of the rolling chassis and/or the handling system when the control console (12) is removed from the docking support (212);
and in that, in the state whereby it is positioned in or on the docking support

(212) the control console (12) is pivotably mounted (R12) relative to or with the docking support (212) so as to form a steering control component, such as a steering wheel, via said pivoting mobility so as to allow the driver present in the control station (202) of the machine to control a system (23) for steering the wheels of the machine by pivoting (R12) the control console (12).

2. The machine (1) as claimed in claim 1, wherein in the state whereby it is positioned in or on the docking support (212), the control console (12) is pivotably securely mounted with the docking support (212), which comprises a shaft (211), called steering shaft, coupled to the wheel steering system (23) such that pivoting the control console (12) pivots the steering shaft (211) relative to the rolling chassis (2).

3. The machine (1) as claimed in any one of the preceding claims, wherein the control station (202) of the machine is devoid of an additional steering control component that can be used instead of the control console (12).

4. The machine as claimed in any one of the preceding claims, wherein the control console (12) comprises a rechargeable battery (129) and an electrical connection system (124) connected to the battery (129), the electrical connection system (124) of the control console (12) is configured, in the state whereby the control console (12) is positioned in or on the docking support (212), to be connected to an electrical connection system (2124) of the docking support (212) to allow the battery (129) to be recharged by an electrical power supply system (24) of the machine.

5. The machine as claimed in claim 4, wherein the module (706) for detecting the state of the control console is connected to the electrical connection system (2124) of the docking support (212) so as to detect the position of the control console (12) in or on the docking support (212) when the electrical connection system (124) of the control console (12) is connected to the electrical connection system (2124) of the docking support (212).

6. The machine as claimed in any one of the preceding claims, wherein the electrical connection system (124) of the control console (12) is located on a lateral face and/or on a lower face, as opposed to an upper face of the control console (12) that supports the control device (2123) for controlling the system for moving the rolling chassis of the machine on the ground and the control device (2126) for controlling the handling system (600) of the machine, while the electrical connection system (2124) of the docking support (212) is located on a lateral face and/or on an upper face of the docking support (212), so as to allow the electrical connection systems (124, 2124) to be automatically connected to each other when the user places the control console (12) in the docking support (212) under the effect of gravity.

7. The machine as claimed in any one of the preceding claims, wherein the machine comprises a locking system (213) for locking the control console (12) so as to hold it in position in or on the docking support (212), and for unlocking the control console (12) from the docking support (212) so as to remove it.

8. The machine as claimed in any one of the preceding claims, wherein the device (2123) for controlling the system for moving the rolling chassis of the machine on the ground is configured to allow the following to be controlled:
the speed and/or the acceleration of the movement of the rolling chassis of the machine on the ground; and
the line of travel of the rolling chassis of the machine on the ground; and
at least in degraded mode, the direction of the machine in order to allow a user to control the direction of movement of the rolling chassis of the machine on the ground from outside the control station.

9. The machine as claimed in any one of the preceding claims, wherein the handling system (600) comprises a lifting arm (6) that can be inclined relative to the rolling chassis (2), between a low position and a high position, the lifting arm (6) being provided with handling equipment (14), such as a work platform or a fork system, movably mounted relative to the lifting arm (6), the lifting arm (6) preferably being telescopic and preferably being pivotably mounted at the rear of the machine,
the control device (2126) for controlling the handling system (600) of the machine is configured to allow the following to be controlled: the angle of incline of the lifting arm (6) relative to the rolling chassis (2) and/or the movement of the equipment (14) relative to the lifting arm (6).

10. The machine as claimed in any one of the preceding claims, wherein, in degraded mode (M2), the processing unit (10) is configured to limit the maximum value of the speed (V2_max′), or of the acceleration, of movement of the rolling chassis of the machine on the ground relative to the maximum value of the speed (V2_max), or of the acceleration, permitted in nominal mode (M1).

11. The machine (1) as claimed in any one of the preceding claims, wherein the handling system (600) comprises a lifting arm (6) that can be inclined relative to the rolling chassis (2), between a low position and a high position, the lifting arm (6) being provided with handling equipment (14), such as a work platform or a fork system, the lifting arm (6) preferably being pivotably mounted at the rear of the machine, and wherein, in degraded mode (M2), the processing unit (10) is configured to limit the maximum permitted value of the angular speed and/or of the angular acceleration (V′A6_max) of the lifting arm (6) relative to the maximum value of the angular speed (VA6_max) and/or of the angular acceleration of the lifting arm (6) permitted in nominal mode (M1).

12. The machine (1) as claimed in any one of the preceding claims, wherein the handling system (600) comprises a lifting arm (6) that can be inclined relative to the rolling chassis, between a low position and a high position, the lifting arm (6) being provided with handling equipment (14), such as a work platform or a fork system, the lifting arm being telescopic and preferably being pivotably mounted at the rear of the machine,
and wherein, in degraded mode (M2), the processing unit (10) is configured to limit the extension speed (V′T6_max) and/or the maximum permitted extension acceleration of the lifting arm (6) relative to the extension speed (VT6_max) and/or the maximum permitted extension acceleration of the lifting arm (6) in nominal mode (M1).

13. A method for controlling a machine for handling a load or a person as claimed in any one of the preceding claims, the method comprising the following steps of:
with the removable control console (12) being positioned (710) in or on the docking support (212) of the control station (202), with the driver being seated on the seat of the control station and the seat belt of the driver being fastened:
detecting (720) the positioned state of the removable control console (12) in or on the docking support (212);
detecting (730), via the processing unit (10), the presence of a driver on the seat (2021);
detecting (740), via the processing unit (10), the fastened state of the seat belt (2022) of the driver; and
authorizing, via the processing unit (10), the operation of the machine in nominal mode (M1),
and, when the removable control console (12) is removed (750) from the docking support (212) of the control station (202), or the driver is not seated on the seat of the control station or the seat belt of the driver is unfastened:
detecting (760), via the processing unit (10), the state whereby the removable control console (12) is removed from the docking support (212), or the absence of the driver on the seat of the control station or the unfastened state of the seat belt of the driver; and
limiting (770), via the processing unit (10), the operation of the machine to the degraded mode (M2);
with the degraded operating mode (M2) being an operating mode in which:
the maximum permitted value of at least one operating parameter of the machine is reduced relative to the maximum permitted value of said operating parameter of the machine in nominal mode (M1); and/or
a function of the machine available in nominal mode (M1) is deactivated in degraded mode (M2);
and, when the removable control console (12) is positioned in or on the docking support (212), the driver controlling the direction of the wheels of the machine by pivoting the control console (12) relative to or with the docking support (212);
and, when the removable control console (12) is removed from the docking support (212), the driver controlling the direction of the wheels of the machine by acting on the control device (2123) for controlling the ground movement system that forms part of the control console (12).
